(19) United States
(12) Patent Application Publication
(10) Pub. No.: US 2023/0030389 A1
(43) Pub. Date: Feb. 2, 2023

(54) Multi-User Account Authentication Question Generation

(71) Applicant: Capital One Services, LLC, McLean, VA (US)

(72) Inventors: Viraj Chaudhary, Katy, TX (US); David Septimus, New York, NY (US); Jenny Melendez, Falls Church, VA (US); Samuel Rapowitz, Roswell, GA (US); Tyler Maiman, Melville, NY (US); Joshua Edwards, Philadelphia, PA (US)

(21) Appl. No.: 17/387,690

(22) Filed: Jul. 28, 2021

(51) Int. Cl. G06Q 20/40; H04L 29/06

(52) U.S. Cl. CPC G06Q 20/4014; H04L 63/104; H04L 63/0838

(57) ABSTRACT

Methods, systems, and apparatuses are described herein for authenticating access to an account using questions relating to which user, of a plurality of users authorized to access the account, performed certain actions. A request for access to an account may be received. Transaction data for the account may be received. A list of merchants may be generated for at least one transaction. An authentication question relating to the identity of a user that conducted a transaction may be generated. For example, the authentication question may prompt the user to indicate which authorized user(s) conducted particular transaction(s). The user device may be provided the authentication question. A response to the authentication question may be received. Access to the account may be provided based on the response.

### FIELD OF USE

Aspects of the disclosure relate generally to account security. More specifically, aspects of the disclosure may provide for improvements in the method in which authentication questions are generated by analyzing activity by a plurality of different authorized users of an account.

### BACKGROUND

As part of determining whether to grant a user access to content (e.g., as part of determining whether to provide a caller access to a telephone system that provides banking information), a user of the user device may be prompted with one or more authentication questions. Such questions may relate to, for example, a password of the user, a personal identification number (PIN) of the user, or the like. Those questions may additionally and/or alternatively be generated based on personal information of the user. For example, when setting up an account, a user may provide a variety of answers to predetermined questions (e.g., “Where was your father born?,” “Who was your best friend in high school?”), and those questions may be presented to the user as part of an authentication process. As another example, a commercially-available database of personal information may be queried to determine personal information for a user (e.g., their birthdate, birth state, etc.), and that information may be used to generate an authentication question (e.g., “Where were you born, and in what year?”).

As part of authenticating a computing device, information about financial transactions conducted by a user of that computing device may be used to generate authentication questions as well. For example, a user may be asked questions about one or more transactions conducted by the user in the past (e.g., “Where did you get coffee yesterday?,” “How much did you spend on coffee yesterday?,” or the like). Such questions may prompt a user to provide a textual answer (e.g., by inputting an answer in a text field), to select one of a plurality of answers (e.g., select a single correct answer from a plurality of candidate answers), or the like. In some instances, the user may be asked about transactions that they did not conduct. For example, a computing device may generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user may be able to glean personal information about the legitimate user.

One significant risk in using authentication questions is that the answer to authentication questions may be determined using stolen data. For example, for a financial account, many questions may be answerable by a malicious actor if that malicious actor acquires the general ledger of the financial account. In this manner, if the malicious user were to steal the mail of an authorized user, they may be able to determine the answer to authentication questions.

Aspects described herein may address these and other problems, and generally improve the safety of financial accounts and computer transaction systems by determining which user of a plurality of authorized users conducted a transaction, then using that information as part of the authentication process.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to generating and using authentication questions which pertain to which user (e.g., of a plurality of users authorized to access an account) conducted a particular transaction. This information might not be reflected in, e.g., the general ledger of the account, and thus might not be determinable by a malicious actor even if they were to gain unauthorized access to the account (and/or, e.g., a user's mail). For example, such information may be determined by a machine learning model trained to identify user spending patterns.

More particularly, some aspects described herein may provide for a computing device that may receive, from a user device, a request for access to an account associated with a plurality of authorized users. The computing device may retrieve transaction data for the account. That transaction data may indicate a plurality of transactions. Each transaction of the plurality of transactions may be associated with a merchant and associated with at least one of the plurality of authorized users. The computing device may generate a list of merchants that match at least one transaction indicated by the transaction data. The computing device may prompt the user device for a plurality of responses indicating, for each merchant of the list of merchants, which authorized user of the plurality of authorized users is associated with the transaction. The computing device may receive the plurality of responses from the user device. The computing device may calculate an authentication score based on the plurality of responses. The computing device may provide, to the user device, access to the account based on the authentication score.

According to some embodiments, the computing device may train, using training data, a machine learning model to identify user spending patterns. That training data may comprise a history of transactions conducted by different users. The computing device may then generate, based on the transaction data, for each user of the plurality of authorized users, machine learning inputs. The computing device may then provide the machine learning inputs to the trained machine learning model and receive, from the trained machine learning model and based on the machine learning inputs, machine learning output. The computing device may then generate, based on the machine learning output, spending patterns for each authorized user. The spending patterns may indicate one or more of: a merchant or type of merchant that a particular authorized user typically transacts with; and a merchant or type of merchant that a particular authorized user does not typically transact with. The computing device may then determine, based on the spending patterns, that a transaction associated with a particular authorized user should instead be associated with a different authorized user. The computing device may, based on the determination that the transaction associated with the particular authorized user should instead be associated with the different authorized user, remove a merchant associated with the transaction from the list of merchants. The computing device may, based on the determination that the transaction associated with the particular authorized user should instead be associated with the different authorized user, reduce an influence, on the authentication score, of an incorrect response for the merchant associated with the transaction.

According to some embodiments, the computing device may determine, based on location data for a particular authorized user and location data for a particular merchant, that a transaction associated with the merchant and the particular authorized user should instead be associated with a different authorized user. The computing device may then, based on the determination that the transaction associated with the merchant and the particular authorized user should instead be associated with a different authorized user, remove a merchant associated with the transaction from the list of merchants. The computing device may generate the list of merchants by generating an initial list of merchants that match the transaction data and retrieving a machine learning model trained to output a memorability score. That machine learning model may be trained using training data comprises inputs indicating various merchants and labeled outputs indicating memorability scores. The computing device may then generate, for each merchant of the initial list of merchants, a memorability score by providing, the trained machine learning model, an input indicating the corresponding merchant. Then, the computing device may, based on the memorability score for one or more merchants failing to satisfy a threshold, remove the one or more merchants from the initial list of merchants to yield the list of merchants. The computing device may receive of the plurality of responses from the user device by receiving a response indicating that none of the plurality of authorized users transacted with a particular merchant. In that situation, the calculating of the authentication score may be based on whether the particular merchant matches the transaction data. The computing device may receive the plurality of responses from the user device by receiving a response indicating uncertainty about which authorized user transacted with a particular merchant. In that situation, the calculating of the authentication score may be based on the response indicating uncertainty about which authorized user transacted with a particular merchant.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for determining users associated with transactions and presenting authentication questions;

FIG. 5 depicts a flow chart comprising steps which may be performed for using a trained machine learning model to determine spending patterns; and

FIG. 6 depicts examples of authentication questions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving authentication questions used during an authentication process. In particular, the process depicted herein may analyze transactions for an account (e.g., an account associated with multiple authorized users) to generate authentication questions pertaining to which user, of a plurality of users, conducted a particular transaction.

As an example of one problem addressed by the current disclosure, an authentication system may generate and present authentication questions relating to transactions conducted by an account. That said, some of those authentication questions may be easily guessable and/or may be determined by analyzing stolen information. For example, a malicious user may steal a legitimate user's mail to receive a checking account statement, then use that information to infer the answers to authentication questions and thereby gain access to an online financial account portal. With that said, it can also be undesirable to generate particularly complicated authentication questions: while such complexity may prevent a malicious user from guessing or otherwise gleaning the answer to the complicated authentication questions, it may simultaneously prevent legitimate users from accessing their own account. To address these another issues, the present disclosure uses the identity of users that conducted a transaction to generate authentication questions that are memorable, but also difficult to guess or derive from the general ledger of an account. For example, by asking a user to identify which member of a household used a debit card to purchase coffee at a specific time, a computing device may ask a personal and fairly easy question for a legitimate user, but also a question that is significantly more difficult for a malicious user to guess. Moreover, by using the machine learning models described herein, such a process may be performed without radically changing the transaction process: for example, by using a machine learning model to identify spending trends and identify transactions likely associated with specific users, those users need not manually specify which transactions they have conducted.

Aspects described herein improve the functioning of computers by improving the way in which computers provide authentication questions and protect computer-implemented accounts. The speed and processing complexity of computing devices allows them to present more complicated authentications than ever before, which advantageously can improve the security of sensitive account information. That said, the algorithms with which authentication questions are generated can have security holes, which may render those authentication questions undesirably vulnerable to exploitation. Such exploitation can result in the illegitimate use and abuse of computer resources. The processes described herein improve this process by analyzing transactional data and using machine learning models in a way that improves the safety of authentication questions. Such steps cannot be performed by a user and/or via pen and paper at least because the problem is fundamentally rooted in computing processes, involves a significantly complex amount of data and information processing, and requires steps (e.g., authenticating computerized requests for access, use of a machine learning model) which cannot be performed by a human being.

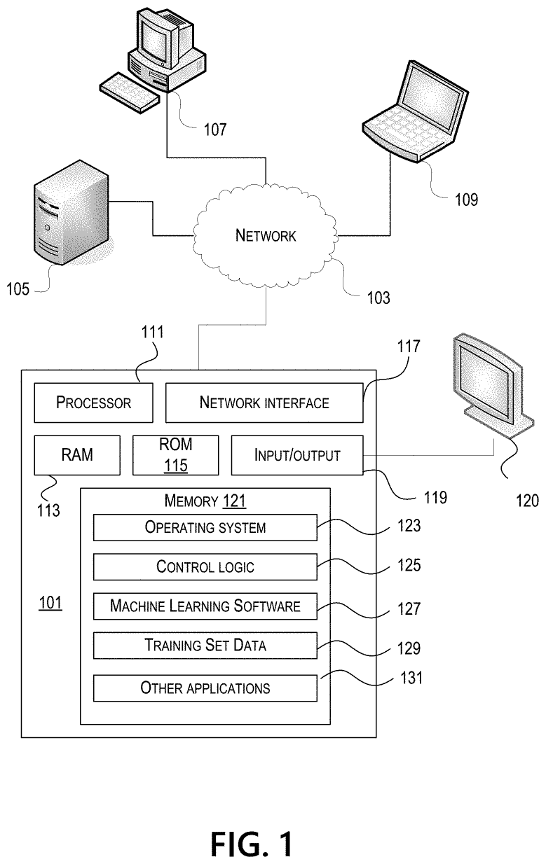

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

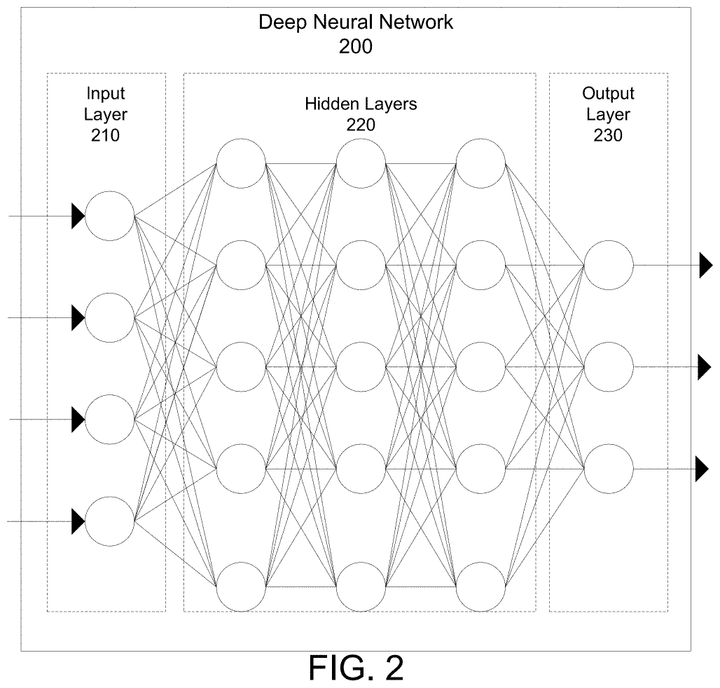

FIG. 2 illustrates an example deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

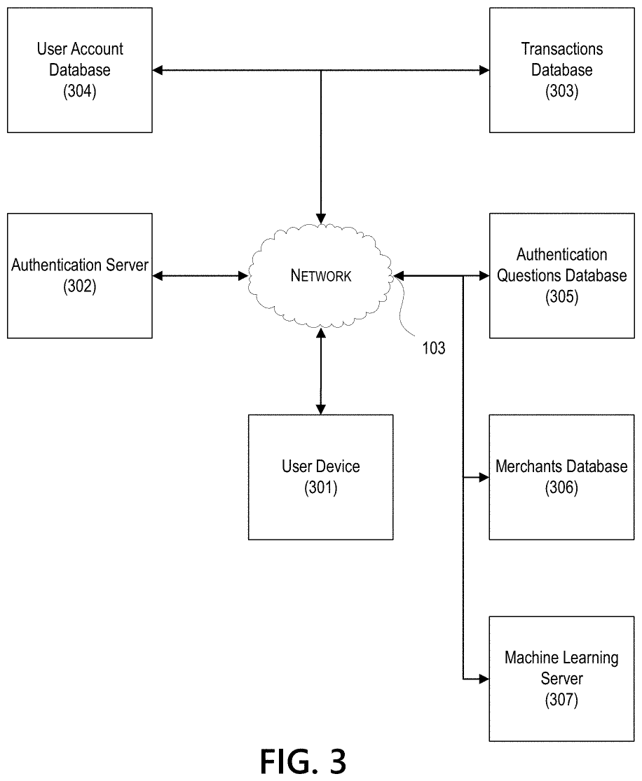

FIG. 3 depicts a system for authenticating a user device 301. The user device 301 is shown as connected, via the network 103, to an authentication server 302, a transactions database 303, a user account database 304, an authentication questions database 305, a merchants database 306, and a machine learning server 307. The network 103 may be the same or similar as the network 103 of FIG. 1. Each of the user device 301, the authentication server 302, the transactions database 303, the user account database 304, the authentication questions database 305, the merchants database 306, and/or the machine learning server 307 may be one or more computing devices, such as a computing device comprising one or more processors and memory storing instructions that, when executed by the one or more processors, perform one or more steps as described further herein. For example, any of those devices may be the same or similar as the computing devices 101, 105, 107, and 109 of FIG. 1.

As part of an authentication process, the user device 301 may communicate, via the network 103, to access the authentication server 302 to request access (e.g., to a user account). The user device 301 shown here may be a smartphone, laptop, or the like, and the nature of the communications between the two may be via the Internet, a phone call, or the like. For example, the user device 301 may access a website associated with the authentication server 302, and the user device 301 may provide (e.g., over the Internet and by filling out an online form) candidate authentication credentials to that website. The authentication server 302 may then determine whether the authentication credentials are valid. For example, the authentication server 302 may compare the candidate authentication credentials received from the user device 301 with authentication credentials stored by the user account database 304. In the case where the communication is telephonic, the user device 301 need not be a computing device, but may be, e.g., a conventional telephone.

The user account database 304 may store information about one or more user accounts, such as a username, password, demographic data about a user of the account, or the like. For example, as part of creating an account, a user may provide a username, a password, and/or one or more answers to predetermined authentication questions (e.g., “What is the name of your childhood dog?”), and this information may be stored by the user account database 304. The authentication server 302 may use this data to generate authentication questions. The user account database 304 may store demographic data about a user, such as their age, gender, location, occupation, education level, income level, and/or the like.

The transactions database 303 may comprise data relating to one or more transactions conducted by one or more financial accounts associated with a first organization. For example, the transactions database 303 may maintain all or portions of a general ledger for various financial accounts associated with one or more users at a particular financial institution. The data stored by the transactions database 303 may indicate one or more merchants (e.g., where funds were spent), an amount spent (e.g., in one or more currencies), a date and/or time (e.g., when funds were spent), or the like. The data stored by the transactions database 303 may be generated based on one or more transactions conducted by one or more users. For example, a new transaction entry may be stored in the transactions database 303 based on a user purchasing an item at a store online and/or in a physical store. As another example, a new transaction entry may be stored in the transactions database 303 based on a recurring charge (e.g., a subscription fee) being charged to a financial account. As will be described further below, synthetic transactions may be based, in whole or in part, on legitimate transactions reflected in data stored by the transactions database 303. In this way, the synthetic transactions may better emulate real transactions.

The account data stored by the user account database 304 and the transactions database 303 may, but need not be related. For example, the account data stored by the user account database 304 may correspond to a user account for a bank website, whereas the financial account data stored by the transactions database 303 may be for a variety of financial accounts (e.g., credit cards, checking accounts, savings accounts) managed by the bank. As such, a single user account may provide access to one or more different financial accounts, and the accounts need not be the same. For example, a user account may be identified by a username and/or password combination, whereas a financial account may be identified using a unique number or series of characters.

The authentication questions database 305 may comprise data which enables the authentication server 302 to present authentication questions. An authentication question may be any question presented to one or more users to determine whether the user is authorized to access an account. For example, the question may be related to personal information about the user (e.g., as reflected by data stored in the user account database 304), may be related to past transactions of the user (e.g., as reflected by data stored by the transactions database 303), or the like. The authentication questions database 305 may comprise data for one or more templates which may be used to generate an authentication question based on real information (e.g., from the user account database 304 and/or the transactions database 303) and/or based on synthetic information (e.g., synthetic transactions which have been randomly generated and which do not reflect real transactions). The authentication questions database 305 may additionally and/or alternatively comprise one or more static authentication questions, such as an authentication question that is used for a wide variety of users (e.g., “What is your account number?”). An authentication question may correspond to a synthetic transaction (e.g., a transaction which never occurred). For example, a synthetic transaction indicating a $10 purchase at a coffee shop on Wednesday may be randomly generated, and the authentication question could be, e.g., “Where did you spent $10 last Wednesday?,” “How much did you spend at the coffee shop last Wednesday?,” or the like. In all such questions, the correct answer may indicate that the user never conducted the transaction. As part of generating authentication questions based on synthetic transactions, merchants may be randomly selected from a list of merchants stored by the merchants database 306. Additionally and/or alternatively, as part of generating such authentication questions based on synthetic transactions, real transactions (e.g., as stored in the transactions database 303) may be analyzed. In this manner, real transactions may be used to make synthetic transactions appear more realistic. The authentication questions database 305 may additionally and/or alternatively comprise historical authentication questions. For example, the authentication questions database 305 may comprise code that, when executed, randomly generates an authentication question, then stores that randomly-generated authentication question for use with other users.

The authentication questions stored in the authentication questions database 305 may be associated with varying levels of difficulty. For example, straightforward answers that should be easily answered by a user (e.g., “What is your mother's maiden name?”) may be considered easy questions, whereas complicated answers that require a user to remember past transactions (e.g., “How much did you spend on coffee yesterday?”) may be considered difficult questions.

The merchants database 306 may store data relating to one or more merchants, including indications (e.g., names) of merchants, aliases of the merchants, locations of the merchants, and the like. That data may be used to generate authentication questions that comprise both correct answers (e.g., based on data from the transactions database 303 indicating one or more merchants where a user has in fact conducted a transaction) and synthetic transactions (e.g., based on data from the merchants database 306, which may be randomly-selected merchants where a user has not conducted a transaction). For example, a computing device may, as part of randomly generating a synthetic transaction using instructions provided by the authentication questions database 305, generate a synthetic transaction by querying the merchants database 306 for a list of merchants, then removing, from that list, merchants represented in the data stored by the transactions database 303.

The machine learning server 307 may provide one or more machine learning models which may, e.g., be implemented using the machine learning software 127 and/or the deep neural network 200. Such machine learning models may be trained using training data. Training data may comprise tagged data, such as sets of data that have been tagged with optimal output from the machine learning model. For example, training data may comprise a plurality of transactions and an indication of a spending pattern reflected by those transactions (e.g., a frugal married mother of three, a broke and single college student, a married 30something female that frequently travels and dines out). Using that training data, a machine learning model may be trained to provide output in response to new input data. For example, using the training data referenced above, the machine learning model may provide output indicating a spending pattern in response to input data comprising a plurality of transactions.

Having discussed several examples of computing devices which may be used to implement some aspects as discussed further below, discussion will now turn to a method for generating and presenting authentication questions based on the identity of users that conducted transactions.

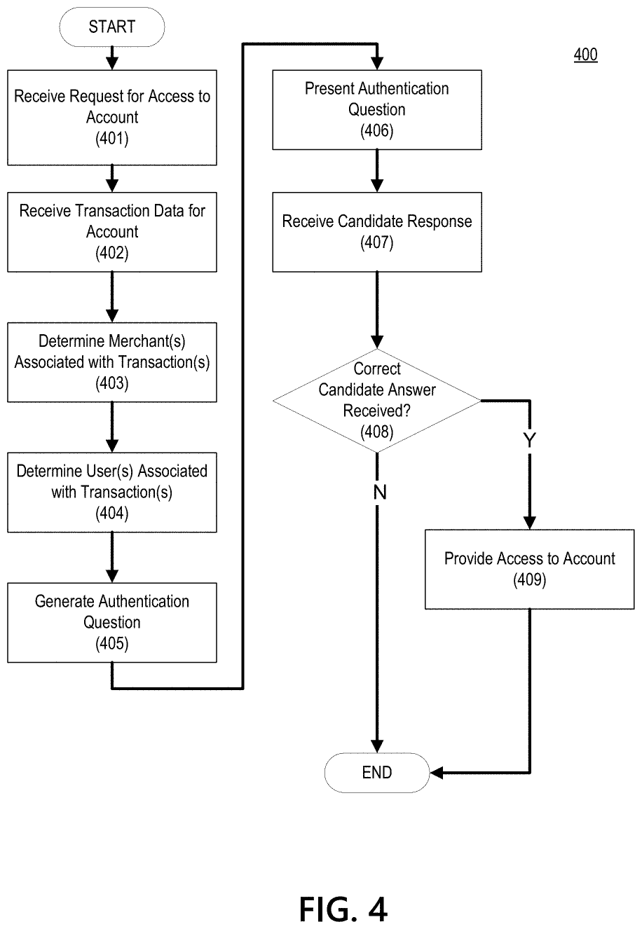

FIG. 4 illustrates an example method 400 for generating and presenting authentication questions based on the identity of users that conducted transactions in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged or otherwise modified as desired.

In step 401, the computing device may receive a request for access to an account. For example, the computing device may receive, from a user device, a request for access to an account associated with a plurality of authorized users. The request may be associated with access, by a user, to a website, an application, or the like. The request may additionally and/or alternatively be associated with, for example, a user device calling into an Interactive Voice Response (IVR) system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user may call an IVR system and be identified (e.g., using caller ID) by their telephone number, which may be used to query the user account database 304 for a corresponding account.

In step 402, the computing device may receive transaction data for the account. The transaction data may be received from the transactions database 303, and may relate to a particular account. For example, the computing device may retrieve transaction data for the account. That transaction data may indicate a plurality of transactions. For example, the transaction data may indicate a plurality of different transactions (e.g., purchases of goods and/or services) associated with an account over a period of time (e.g., the last month). Each transaction of the plurality of transactions may be associated with a merchant and associated with at least one of the plurality of authorized users. For example, each of the plurality of transactions may have been conducted at one or more merchants (e.g., a coffee shop, a shopping mall, etc.) and may have been conducted by one or more of a plurality of different authorized users of the account (e.g., one or more of three different users that share a checking account).

In step 403, the computing device may determine one or more merchants associated with one or more transactions. As indicated above, the transaction data may indicate one or more merchants where each of a plurality of different transactions may have been conducted. With that said, the computing device need not determine all merchants for all transactions indicated in the transaction data. Rather, the computing device may select a subset of the transactions, then determine one or more merchants that correspond to that subset. This subset may be as small as a single transaction. For example, the computing device may generate a list of merchants that match at least one transaction indicated by the transaction data.

Determining the list of merchants may comprise use of a machine learning model to analyze the memorability of merchants. Some merchants may correlate to transactions that might not be particularly memorable. For example, a legitimate user may regularly purchase snacks at small corner stores in a city, but might not necessarily know the formal business name of those small corner stores. In such a circumstance, the legitimate user might not easily identify whether they (and/or another authorized user) conducted a transaction at the corner store when presented with the formal business name. The computing device may generate an initial list of merchants that match the transaction data. Then, the computing device may retrieve a machine learning model trained to output a memorability score. Such a machine learning model may be retrieved from the machine learning server 307. That machine learning model may be trained using training data that comprises inputs indicating various merchants and labeled outputs indicating memorability scores. A memorability score may be a Boolean value (e.g., “Memorable,” “Not Memorable”), a percentage (e.g., “60% Memorable”), or a similar representation of a degree of memorability of a particular merchant. In other words, the machine learning model may be trained to recognize whether certain merchants (e.g., merchant categories, merchant names, etc.) are memorable or not. The computing device may generate, for each merchant of the initial list of merchants, a memorability score by providing, the trained machine learning model, an input indicating the corresponding merchant. For example, the computing device may provide the initial list of merchants to the machine learning model and receive, as output from the machine learning model, an indication of a memorability of each merchant in the initial list of merchants. Then, the computing device may, based on the memorability score for one or more merchants failing to satisfy a threshold, remove the one or more merchants from the initial list of merchants to yield the list of merchants. For example, if a memorability score for a particular merchant is 40% and thereby fails to satisfy a threshold that requires a 50%-or-greater memorability score, the particular merchant may be removed from the initial list of merchants. In this manner, a merchant that a user may regularly forget about may be removed from the list of merchants.

In step 404, the computing device may determine one or more users associated with the one or more transactions. Determining the one or more users associated with the one or more transactions may comprise determining which user of a plurality of different authorized users was associated with a particular transaction. For example, a user may be said to be associated with a particular transaction because they swiped a transaction card at a point-of-sale system to conduct the transaction, entered financial account details into an online form to conduct an online transaction, or the like. In this manner, transactions associated with the same account (e.g., the same credit card and/or debit card) may be separated based on which user (e.g., of a plurality of different authorized users of the same credit card/debit card) is associated with (e.g., conducted) the transaction.

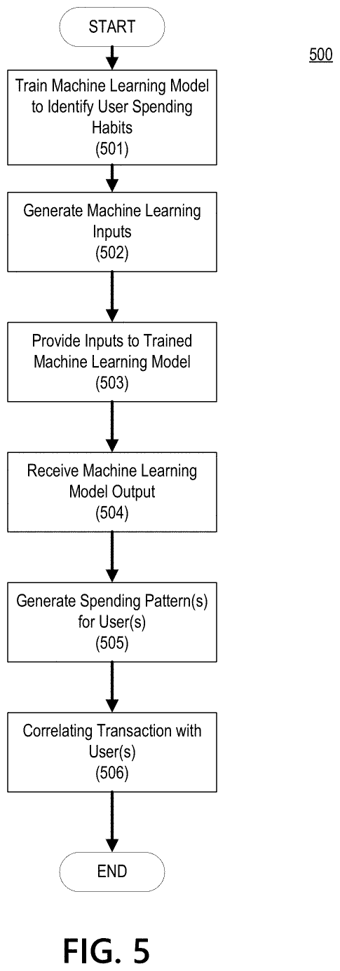

The particular identity of which of a plurality of different authorized users conducted a transaction might not be reflected by the transaction data received in step 402. For example, if three authorized users share a single credit card, then a swipe of the credit card at a point-of-sale kiosk might not indicate which particular user swiped the card. In such a circumstance, the computing device may infer which user is associated with a particular transaction. As will be discussed below (and with respect to FIG. 5), a machine learning model may be used to determine spending patterns which may allow the computing device to infer which transaction(s) are associated with a specific user. That said, in some instances the transaction data may indicate which user of a plurality of different authorized users is associated with a transaction. For example, where a user specified a billing name and address as part of conducting an online purchase, the billing name used may indicate which user is associated with the transaction. In such circumstances, the computing device may decide which user is associated with a particular transaction based on indication(s) of the identity of such a user in the transaction data received in step 402.

Location data may be used to determine one or more users associated with the one or more transactions. Because users often carry personal computers (e.g., smartphones) with them, location data from such personal computers can be used to determine the location of that user during a transaction. In this manner, the computing device may use the location of a user to determine whether or not the user conducted a particular transaction. For example, the computing device may determine, based on location data for a particular authorized user and location data for a particular merchant, that a transaction associated with the merchant and the particular authorized user should instead be associated with a different authorized user. To receive such location data, the computing device may (with the permission of a user) request and receive the location data from a computing device (e.g., a smartphone) associated with the user. Such data may comprise, for example, a series of Global Positioning System (GPS) coordinates. That location data may then be compared to a location of one or more merchant(s) (e.g., as stored in the merchants database 306) to determine whether a user was at a location associated with a merchant around a time when a transaction occurred. If a particular user was not at a location associated with a merchant when a transaction occurred, that fact may suggest that the particular user is not associated with the transaction (and, e.g., another authorized user is associated with the transaction). In that example, the computing device may then, based on the determination that the transaction associated with the merchant and the particular authorized user should instead be associated with a different authorized user, remove a merchant associated with the transaction from the list of merchants. In that example, the merchant may be removed such that the authorization question generated below in step 405 does not incorrectly indicate that the particular user is associated with the transaction.

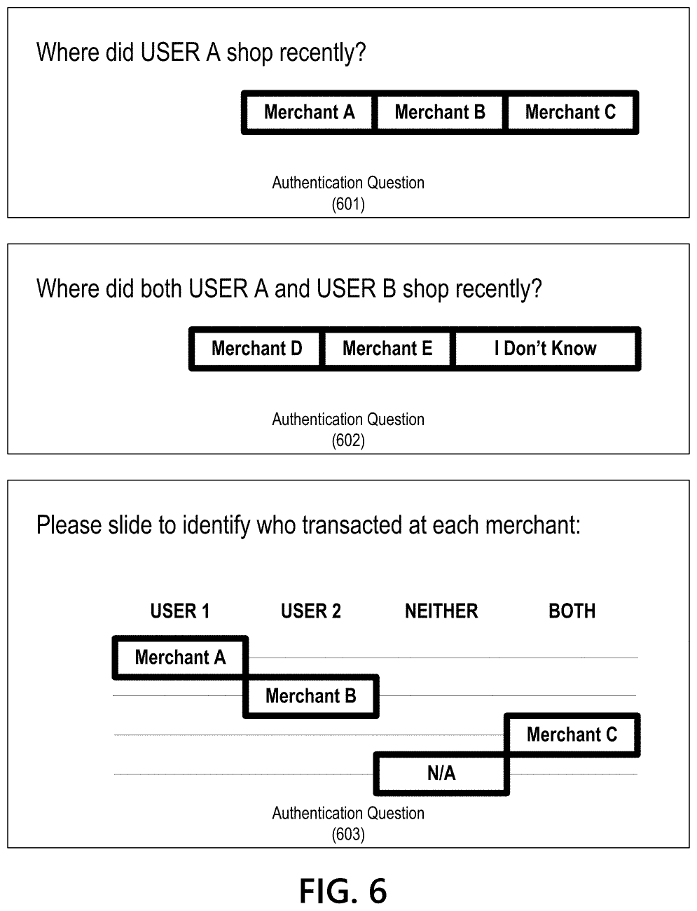

In step 405, the computing device may generate an authentication question. Generating an authentication question may comprise generating an authentication question based on the one or more users determined to be associated with the one or more transactions, as performed in step 404. Generating an authentication question may additionally and/or alternatively be based on the one or more merchants determined in step 403. For example, the authentication question may prompt a user to identify one or more different merchants where one or more different authorized users shopped over a period of time. The authentication question need not pertain to the requesting user's own habits: for example, one authorized user (e.g., a wife) may be asked questions about merchants where another authorized user (e.g., her husband) has shopped over the last month. The authentication question may be generated to have one or more correct answers and/or one or more incorrect answers. Examples of such authentication questions are discussed below with respect to FIG. 6.

The authentication question may ask a user to identify which user(s) did or did not conduct transactions at particular merchants. For example, as part of step 403, a list of merchants may be determined. That list of merchants may correspond to a plurality of different transactions conducted by a plurality of different authorized users. Then, the user requesting authentication (e.g., as reflected by the request for access received in step 401) may be asked to indicate, for each of the list of merchants, whether they (as one authorized user) shopped at that merchant, whether another authorized user shopped at that merchant, whether both they and the another authorized user shopped at the same merchant, and/or whether neither they nor the another authorized user shopped at the merchant. This authentication question may be particularly powerful because it may be relatively easy for a legitimate user (e.g., because they likely remember where they or a loved one shopped), but may be fairly difficult for a malicious user (e.g., because it may require detailed knowledge of the users' shopping activities in a manner that cannot be gleaned from a general ledger of a financial account).

The authentication question may relate, in whole or in part, to a synthetic transaction. For example, an authentication question may ask a user to identify whether no authorized users conducted a transaction at a particular merchant. To generate such an authentication question, the computing device may randomly select a merchant from the merchants database 306, and/or may generate a synthetic transaction (as described above with respect to the authentication questions database 305). Then, such a merchant and/or synthetic transaction may be used along with legitimate transactions. For example, a user may be prompted to indicate, for each of a plurality of different merchants, whether a particular authorized user conducted a transaction at the merchant recently or whether no authorized user conducted any transactions at the merchant.

In step 406, the computing device may present the authentication question. Presenting the authentication question may comprise causing the authentication question to be displayed (e.g., in a user interface, such as on a website) or presented (e.g., in audio or video form). Presenting the authentication question may comprise presenting a plurality of different answer options for a user. For example, the computing device may prompt the user device for a plurality of responses indicating, for each merchant of the list of merchants, which authorized user of the plurality of authorized users is associated with the transaction.

In step 407, the computing device may receive a candidate response to the authentication question. The candidate response may comprise an indication of one or more answers to the authentication question presented in step 406. For example, the computing device may receive a plurality of responses from the user device. A candidate response may be any indication of a response, by a user, to the authentication question presented in step 406. For example, where an authentication question comprises one or more answers, the candidate response may comprise a selection of at least one of the one or more answers. As another example, in the case of a telephone call, the candidate response may comprise an oral response to an authentication question provided using a text-to-speech system over the call.

Receiving the candidate response may comprise receiving an indication that none of a plurality of users transacted with a particular merchant. In some instances, the authentication question may relate to a synthetic transaction, such as a merchant where no authorized user(s) conducted a transaction. In such a circumstance, when presented with an authorization question premised on the synthetic transaction, the user may be tested as to whether they recognize that none of the authorized users of the account conducted the synthetic transaction. For example, the computing device may receive a response indicating that none of the plurality of users transacted with a particular merchant. In that situation, the calculating of the authentication score may be based on whether the particular merchant matches the transaction data.

Receiving the candidate response may comprise receiving an indication of uncertainty. A user might not be perfectly certain as to whether they or another authorized user conducted a particular transaction at a particular merchant. To account for this circumstance, the authentication question may in some circumstances allow a user to indicate uncertainty by, e.g., selecting an answer such as “I don't know.” The computing device may then receive a response indicating uncertainty about which authorized user transacted with a particular merchant. For example, the user may select the “I don't know” option. In that situation, authentication of the user (e.g., the calculating of the authentication score, as will be discussed below) may be based on the response indicating uncertainty about which authorized user transacted with a particular merchant. For example, a new authentication question may be generated and presented to the user. As another example, if the uncertainty pertains to a portion of an authentication question related to a synthetic transaction (e.g., the user does not know whether they conducted the transaction because the transaction never occurred and the user is confused), this uncertainty may be considered a correct answer to the authentication question.

In step 408, the computing device may determine whether the candidate response received in step 407 was correct. Determining whether the candidate answer is correct may comprise comparing the answer to a correct answer determined as part of generating the synthetic authentication question in step 405. If so, the method 400 proceeds to step 409. Otherwise, the method 400 ends.

Determining whether the candidate response received in step 407 was correct may be based on an authentication score. An authentication question may ask a user to provide a plurality of different responses. For example, the user may be prompted to indicate, for four different merchants, whether they conducted the transaction, whether another user conducted the transaction, whether both users conducted the transaction, and/or whether neither user conducted the transaction. The computing device may calculate an authentication score based on the plurality of responses. For example, the user may be provided one point for a correct answer and zero points for incorrect answers. Then, the computing device may provide, to the user device, access to the account based on the authentication score. For example, if the user answers at least 75% of the questions correctly, then the user may be granted access to the account. In this manner, the user need not perfectly recall all information to be provided access to the account.

In step 409, the computing device may provide access to the account. Access to the account may be provided by, e.g., providing a user device access to a protected portion of a website, transmitting confidential data to a user device, allowing a user to request, modify, and/or receive personal data (e.g., from the user account database 304 and/or the transactions database 303), or the like.

FIG. 5 illustrates an example method 500 for training a machine learning model and using that machine learning model to determine spending patterns in accordance with one or more aspects described herein. The method 500 may be implemented by a suitable computing system, as described further herein. For example, the method 500 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 500 may be implemented in suitable program instructions, such as in machine learning software 127, and may operate on a suitable training set, such as training set data 129. The method 500 may be implemented by computer-readable media that stores instructions that, when executed, cause performance of all or portions of the method 400. The steps shown in the method 500 are illustrative, and may be re-arranged or otherwise modified as desired.

The method 500 may be all or portions of the steps depicted in the method 400. For example, the method 500 may be performed as part of step 404 of FIG. 4, and/or may be performed before step 403 of FIG. 4. In this manner, the method 500 illustrates one way in which the steps depicted in the method 400 may be improved through the implementation of machine learning model(s), and may be implemented in various ways throughout the process depicted by the method 400 of FIG. 4.

In step 501, the computing device may train a machine learning model to identify user spending patterns. For example, the computing device may train, using training data, a machine learning model to identify user spending patterns. The machine learning model may thereby be referred to as a trained machine learning model. Such a machine learning model may be implemented by the machine learning software 127, the deep neural network 200, and/or the machine learning server 307. The training data may comprise a history of transactions conducted by different users. The training data may be tagged with an indication of a spending pattern. For example, the training data may comprise a plurality of different transactions associated with a user along with a spending pattern of that user.

Spending patterns may be any subjective or objective representation of the way in which one or more users conduct transactions. Spending patterns may relate to a time of day when transactions are conducted (e.g., that a user typically uses a credit card during business hours of the day), where such transactions are conducted (e.g., a geographic region where a user typically uses a credit card), how such transactions are conducted (e.g., online, in-person using a chip-and-pen point of sale machine), or the like. Spending patterns may additionally and/or alternatively indicate predicted demographics of a user. For example, a spending pattern may suggest that a user spends like an unemployed college student, a married housewife, or an elderly retiree. Spending patterns may additionally and/or alternatively reflect ordinary transactions conducted by a user, which may include the location of, amount of, and/or frequency of such transactions. For example, a spending pattern may indicate that a user usually buys a cheap coffee from a nearby coffeeshop in the morning, spends around ten dollars for lunch in the afternoon during weekdays, and sometimes goes to the grocery store around 7 PM after work.

Spending patterns may relate to a merchant. A spending pattern may indicate a merchant or type of merchant that a particular authorized user typically transacts with. For example, a user may always shop at a particular grocery store or set of grocery stores, and/or may always go to a particular gas station near their home. As another example, a spending pattern may indicate a merchant or type of merchant that a particular authorized user does not typically transact with. For example, though a particular restaurant is near a user's home, a user may never frequent that restaurant for, e.g., dietary reasons.

In step 502, the computing device may generate machine learning inputs. The machine learning inputs may be based on transaction data, such as the transaction data received in step 402 of the method 400 of FIG. 4. The machine learning inputs may be specific to each user of a plurality of users authorized to use an account. For example, the computing device may generate, based on the transaction data, for each user of the plurality of authorized users, machine learning inputs. In this manner, the trained machine learning model may be prompted to provide spending habits on a user-by-user basis. That said, the machine learning inputs may additionally and/or alternatively provide the transactions for all users such that, e.g., the trained machine learning model is prompted to provide output (e.g., a predicted spending pattern) for an entire family.

In step 503, the computing device may provide the inputs to the trained machine learning model. For example, the computing device may provide the machine learning inputs to the trained machine learning model. The inputs may be transmitted to a device executing the trained machine learning model, such as the machine learning server 307.

In step 504, the computing device may receive machine learning model output. The machine learning model output may be provided by the trained machine learning model and in response to the inputs provided in step 503. For example, the computing device may receive, from the trained machine learning model and based on the machine learning inputs, machine learning output. The output need not be a definitive assignment of a spending pattern to a user or set of users. For example, the output may comprise a list of potential spending patterns that may correlate to a user, with different confidence values assigned to each of the potential spending patterns. As another example, the output may comprise an indication of one or more commonalities between transactions in the machine learning inputs, but without an indication as to whether such commonalities are reflective of a spending pattern.

In step 505, the computing device may generate one or more spending patterns for one or more users. The spending patterns may be based on the machine learning model output received in step 504. For example, the computing device may generate, based on the machine learning output, spending patterns for each authorized user. Where the machine learning model output indicates a spending pattern, generating the one or more spending patterns may comprise processing the machine learning model output to identify the spending pattern. As indicated with respect to step 504, the output might not definitively indicate a spending pattern for each user, and thus the output may be used as a basis for determining spending patterns. For example, the machine learning model output may comprise a list of potential spending patterns that may correlate to a user, and generating the one or more spending patterns may comprise selecting one or more spending patterns (e.g., the most likely spending patterns) from that list. As another example, the output may comprise an indication of one or more commonalities between transactions in the machine learning inputs, and generating the one or more spending patterns may comprise determining one or more spending patterns based on those commonalities.

In step 506, the computing device may correlate a transaction with one or more users. Such a correlation step may be based on the spending pattern. For example, the computing device may determine, based on the spending patterns, that a transaction should be associated with a particular authorized user. With that said, the spending patterns may be used to correct errors in data, such as where transactions are incorrectly associated with the wrong authorized user. For example, the computing device may determine, based on the spending patterns, that a transaction associated with a particular authorized user should instead be associated with a different authorized user. In some instances, such a mistake may be based on the identity of a merchant, such that the merchant should be removed from a list of merchants used to formulate an authentication question. For example, based on the determination that the transaction associated with the particular authorized user should instead be associated with the different authorized user, the computing device may remove a merchant associated with the transaction from the list of merchants. Moreover, such a mistake may warrant discounting incorrect answers provided by a user in response to an authentication question. For example, based on the determination that the transaction associated with the particular authorized user should instead be associated with the different authorized user, the computing device may reduce an influence, on the authentication score, of an incorrect response for the merchant associated with the transaction.

FIG. 6 depicts three different examples of authentication questions which may be generated in accordance with the steps described herein. These example authentication questions illustrate various ways in which the identify of users that conducted a transaction may be used as part of an authentication question. Such authentication questions may have been generated as part of step 405 of the method 400 of FIG. 4.

A first authentication question 601 inquires where “USER A” shopped recently, and provides three merchants from which the user may select. The first authentication question 601 is one example of an authentication question which may prompt a user to select, from a plurality of different merchants, one or more merchants where an account was used to conduct a transaction. One or more of these merchants may be correct, such that the user may select multiple options. In some cases, “USER A” may be the same as the user requesting access to the account. The first authentication question 601 may be based on transaction data (e.g., stored by the transactions database 303) that indicates that the account was used to shop at “Merchant B.” The first authentication question 601 may further be based on processing, by a computing device, of such transaction data to indicate that the transaction at “Merchant B” is associated with “USER A.” In other words, the first authentication question 601 may be based on a determination, by the computing device, that the transaction data indicates that “USER A” conducted a transaction at “Merchant B.”

A second authentication question 602 inquires where both “USER A” and “USER B” shopped recently, and provides two merchants from which the user may select. The second authentication question 602 is one example of an authentication question which may prompt a user to select, from a plurality of different merchants, one or more merchants where two or more different users conducted a transaction using the same account. An “I don't know” option is also provided. As with the first authentication question 601, “USER A” may be the same as the user requesting access to the account. One or more of these merchants may be correct, such that the user may select multiple options. For example, the answer to the second authentication question 602 may be both “Merchant D” and “Merchant E,” such that the most correct answer would be to select both options. In the case where the user only selects one of the merchants, the user may be provided half credit towards an authentication score. In the case where the user selects the “I don't know” option, the user might not be provided credit towards an authentication score.

A third authentication question 603 asks a user to indicate, for each of three different merchants, whether a first user, second user, or both users conducted transactions associated with that particular merchant. The third authentication question 603 is one example of an authentication question which may prompt a user to indicate, for a plurality of different users, which user conducted a transaction with one or more of a plurality of different merchants. An “N/A” option is also provided. The third authentication question 603 is provided as a slider, such that the user is prompted to slide each option (“Merchant A,” “Merchant B,” “Merchant C,” and “N/A”) horizontally to indicate whether the option corresponds to “User 1,” “User 2,” “Neither,” or “Both.” In this manner, the user is prompted to answer questions relating to transactions conducted by two different users (e.g., themselves and another authorized user).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving, from a user device, a request for access to an account associated with a plurality of authorized users;
retrieving transaction data for the account, wherein the transaction data indicates a plurality of transactions, wherein each transaction of the plurality of transactions is associated with a merchant and associated with at least one of the plurality of authorized users;
generating a list of merchants that match at least one transaction indicated by the transaction data;
prompting the user device for a plurality of responses indicating, for each merchant of the list of merchants, which authorized user of the plurality of authorized users is associated with the transaction;
receiving the plurality of responses from the user device;
calculating an authentication score based on the plurality of responses; and
providing, to the user device, access to the account based on the authentication score.

2. The method of claim 1, further comprising:
training, using training data, a machine learning model to identify user spending patterns, wherein the training data comprises a history of transactions conducted by different users;
generating, based on the transaction data, for each user of the plurality of authorized users, machine learning inputs;
providing the machine learning inputs to the trained machine learning model;
receiving, from the trained machine learning model and based on the machine learning inputs, machine learning output;
generating, based on the machine learning output, spending patterns for each authorized user; and
determining, based on the spending patterns, that a transaction associated with a particular authorized user should instead be associated with a different authorized user.

3. The method of claim 2, further comprising:
based on the determination that the transaction associated with the particular authorized user should instead be associated with the different authorized user, removing a merchant associated with the transaction from the list of merchants.

4. The method of claim 2, further comprising:
based on the determination that the transaction associated with the particular authorized user should instead be associated with the different authorized user, reducing an influence, on the authentication score, of an incorrect response for the merchant associated with the transaction.

5. The method of claim 2, wherein the spending patterns indicate one or more of:
a merchant or type of merchant that a particular authorized user typically transacts with; and
a merchant or type of merchant that a particular authorized user does not typically transact with.

6. The method of claim 1, further comprising:
determining, based on location data for a particular authorized user and location data for a particular merchant, that a transaction associated with the merchant and the particular authorized user should instead be associated with a different authorized user; and
based on the determination that the transaction associated with the merchant and the particular authorized user should instead be associated with a different authorized user, removing a merchant associated with the transaction from the list of merchants.

7. The method of claim 1, wherein generating the list of merchants comprises:
generating an initial list of merchants that match the transaction data;
retrieving a machine learning model trained to output a memorability score, wherein the machine learning model is trained using training data comprises inputs indicating various merchants and labeled outputs indicating memorability scores;
generating, for each merchant of the initial list of merchants, a memorability score by providing, the trained machine learning model, an input indicating the corresponding merchant; and
based on the memorability score for one or more merchants failing to satisfy a threshold, removing the one or more merchants from the initial list of merchants to yield the list of merchants.

8. The method of claim 1, wherein the receiving of the plurality of responses from the user device comprises:
receiving a response indicating that none of the plurality of authorized users transacted with a particular merchant,
wherein the calculating of the authentication score is based on whether the particular merchant matches the transaction data.

9. The method of claim 1, wherein the receiving of the plurality of responses from the user device comprises:
receiving a response indicating uncertainty about which authorized user transacted with a particular merchant,
wherein the calculating of the authentication score is based on the response indicating uncertainty about which authorized user transacted with a particular merchant.

10. A computing device comprising:
one or more processors; and
memory storing instructions that, when executed by the one or more processors, cause the computing device to:
receive, from a user device, a request for access to an account associated with a plurality of authorized users;
retrieve transaction data for the account, wherein the transaction data indicates a plurality of transactions, wherein each transaction of the plurality of transactions is associated with a merchant and associated with at least one of the plurality of authorized users;
generate a list of merchants that match at least one transaction indicated by the transaction data;
prompt the user device for a plurality of responses indicating, for each merchant of the list of merchants, which authorized user of the plurality of authorized users is associated with the transaction;
receive the plurality of responses from the user device;
calculate an authentication score based on the plurality of responses; and
provide, to the user device, access to the account based on the authentication score.

11. The computing device of claim 10, wherein the instructions, when executed by the one or more processors, further cause the computing device to:
train, using training data, a machine learning model to identify user spending patterns, wherein the training data comprises a history of transactions conducted by different users;
generate, based on the transaction data, for each user of the plurality of authorized users, machine learning inputs;
provide the machine learning inputs to the trained machine learning model;
receive, from the trained machine learning model and based on the machine learning inputs, machine learning output;
generate, based on the machine learning output, spending patterns for each authorized user; and
determine, based on the spending patterns, that a transaction associated with a particular authorized user should instead be associated with a different authorized user.

12. The computing device of claim 11, wherein the instructions, when executed by the one or more processors, further cause the computing device to:
based on the determination that the transaction associated with the particular authorized user should instead be associated with the different authorized user, remove a merchant associated with the transaction from the list of merchants.

13. The computing device of claim 11, wherein the instructions, when executed by the one or more processors, further cause the computing device to:
based on the determination that the transaction associated with the particular authorized user should instead be associated with the different authorized user, reduce an influence, on the authentication score, of an incorrect response for the merchant associated with the transaction.

14. The computing device of claim 11, wherein the spending patterns indicate one or more of:
a merchant or type of merchant that a particular authorized user typically transacts with; and
a merchant or type of merchant that a particular authorized user does not typically transact with.

15. The computing device of claim 10, wherein the instructions, when executed by the one or more processors, further cause the computing device to:
determine, based on location data for a particular authorized user and location data for a particular merchant, that a transaction associated with the merchant and the particular authorized user should instead be associated with a different authorized user; and
based on the determination that the transaction associated with the merchant and the particular authorized user should instead be associated with a different authorized user, remove a merchant associated with the transaction from the list of merchants.

16. One or more non-transitory computer-readable media storing instructions that, when executed by one or more processors, cause a computing device to:
receive, from a user device, a request for access to an account associated with a plurality of authorized users;
retrieve transaction data for the account, wherein the transaction data indicates a plurality of transactions, wherein each transaction of the plurality of transactions is associated with a merchant and associated with at least one of the plurality of authorized users;
generate a list of merchants that match at least one transaction indicated by the transaction data;
prompt the user device for a plurality of responses indicating, for each merchant of the list of merchants, which authorized user of the plurality of authorized users is associated with the transaction;
receive the plurality of responses from the user device;
calculate an authentication score based on the plurality of responses; and
provide, to the user device, access to the account based on the authentication score.

17. The one or more non-transitory computer-readable media of claim 16, wherein the instructions, when executed by the one or more processors, further cause the computing device to:
train, using training data, a machine learning model to identify user spending patterns, wherein the training data comprises a history of transactions conducted by different users;
generate, based on the transaction data, for each user of the plurality of authorized users, machine learning inputs;
provide the machine learning inputs to the trained machine learning model;
receive, from the trained machine learning model and based on the machine learning inputs, machine learning output;
generate, based on the machine learning output, spending patterns for each authorized user; and
determine, based on the spending patterns, that a transaction associated with a particular authorized user should instead be associated with a different authorized user.

18. The one or more non-transitory computer-readable media of claim 17, wherein the instructions, when executed by the one or more processors, further cause the computing device to:
based on the determination that the transaction associated with the particular authorized user should instead be associated with the different authorized user, remove a merchant associated with the transaction from the list of merchants.

19. The one or more non-transitory computer-readable media of claim 17, wherein the instructions, when executed by the one or more processors, further cause the computing device to:
based on the determination that the transaction associated with the particular authorized user should instead be associated with the different authorized user, reduce an influence, on the authentication score, of an incorrect response for the merchant associated with the transaction.

20. The one or more non-transitory computer-readable media of claim 17, wherein the spending patterns indicate one or more of:
a merchant or type of merchant that a particular authorized user typically transacts with; and
a merchant or type of merchant that a particular authorized user does not typically transact with.
